(19) United States
(12) Patent Application Publication
(10) Pub. No.: US 2017/0160594 A1
(43) Pub. Date: Jun. 8, 2017

(54) Polymer Used For Orientation Film Material and Method For Preparing Orientation Film

(71) Applicant: Shenzhen China Star Optoelectronics Technology Co., Ltd., Shenzhen City (CN)

(72) Inventors: Song Lan, Shenzhen City (CN); Xiaolong Ma, Shenzhen City (CN); Yungjui Lee, Shenzhen City (CN)

(21) Appl. No.: 14/785,855

(22) PCT Filed: Jul. 27, 2015
(86) PCT No.: PCT/CN2015/085148

§ 371 Date: Oct. 21, 2015

(30) Foreign Application Priority Data
Jul. 13, 2015 (CN) 201510411136.6

(51) Int. Cl. G02F 1/1337; C09D 179/08; B05D 3/00; C08G 73/16

(52) U.S. Cl. CPC G02F 1/133723; C08G 73/16; C09D 179/085; B05D 3/007; B05D 2505/50

(57) ABSTRACT

The disclosure provides a polymer used for orientation film material and a method for preparing an orientation film. The polymer is formed by siloxane connecting with polyimide. The pre-tilt angle of liquid crystal molecules can be controlled within a wide range by controlling the content of siloxane in polymer, and the polymer has great heat resistance and mechanical properties. The method for preparing an orientation film of the disclosure comprises forming a precursor of orientation film by dissolving siloxane and precursor of polyimide (diamine monomer, dianhydride monomer) in a solvent, coating the precursor of orientation film on a substrate, and obtaining the orientation film after pre-solidifying and main-solidifying, the steps are simple and the prepared orientation film has a wide range of pre-tilt angle, such that the pre-tilt angle of liquid crystal molecules in the liquid crystal panels of the orientation film can be controlled within a wide range.

### TECHNICAL FIELD

The disclosure is related to the field of displays, and more particularly, to a polymer used for orientation film material and a method for preparing an orientation film.

### RELATED ART

Liquid crystal displays (LCD) have many advantages, such as thin structures, power saving, radiationless and so forth, such that they have been widely used. Currently, in the market, most of the liquid crystal displays are backlight liquid crystal displays comprising liquid crystal display panels and backlight modules. The working principles of liquid crystal panels are that liquid crystal molecules are disposed between two parallel glass substrates, the orientation of the liquid crystal molecules are controlled by exerting current through the glass substrates, such that images are generated by the refraction of light of the backlight modules.

In general, liquid crystal display panels are composed of color filter (CF) substrates, thin film transistors (TFT) substrates, liquid crystal (LC) clamped between the CF substrates and the TFT substrates, and sealants. The process for forming thereof comprises: a front stage array process (film, lithography, etching and stripping), middle stage cell process (TFT substrates bonding with CF substrates) and latter stage module assembling process (driving IC and laminating PCB). Wherein, the front stage array process mainly forms TFT substrates for controlling the motion of liquid crystal molecules; the middle stage cell process mainly adds liquid crystals between the TFT substrates and the CF substrates; the latter stage module assembling process integrates driving IC lamination and PCB, so as to drive liquid crystal molecules rotating and display images.

In general, a layer of orientation film is respectively formed on the TFT substrate and the CF substrate, after the orientation film contacting with the LC, a pre-tilt angle is formed by the LC, such that supportive angle is provided to the liquid crystal molecules (the pre-tilt angle has great impact to the driving voltage, contrast ratio, response time and visual angle of the TFT-LCD), the material of the orientation film is usually polyimide (PI). There two main methods for forming the orientation film: (1) rubbing, which applies contact-type directional mechanical friction by flannel wheels on the surface of PI polymer, the energy provided by the friction to the surface of polymer can force the polymer chain extending and directional orientating, so as to control the interaction between the side chain and LC, such that LC would orientate along the direction of pre-tilt angle. (2) Photo-alignment technology, which generates Anisotropy by the photo reaction of UV-sensitive monomer, the liquid crystal molecules interacts with the side chain of the surface of the orientation film. In order to achieve the stable state, which has the lowest energy, liquid crystal molecules orientates along the direction, which receives the maximum force, defined by the light orientation. Although the two methods can cause LC generating a pre-tilt angle, the variation of the pre-tilt angle is within a small range, and the pre-tilt angle cannot be controlled within a greater range.

### SUMMARY

One purpose of the disclosure is to provide a polymer used for orientation film material so as to achieve that the pre-tilt angle of liquid crystal molecules is controllable within a wide range, and it has great heat resistance and mechanical properties.

Another purpose of the disclosure is to provide a method for preparing an orientation film, the steps of the method are simple, and the prepared orientation film can achieve that the pre-tilt angle of liquid crystal molecules is controllable within a wide range, has great heat resistance and mechanical properties.

In order to achieve the above described purposes, the disclosure provides a polymer used for orientation film material, comprising a polyimide chain and a siloxane, connected with the polyimide chain as a side chain, wherein the siloxane has a connective group R and a functional group R′, the connective group R is configured for connecting with the polyimide, and the functional group R′ is configured for controlling a pre-tilt angle of liquid crystal molecules so as to achieve orientating.

The siloxane and the polyimide are connected by one of the following methods:

(I) the connective group R in the siloxane connects with the polyimide, such that the other portion besides the connective group R in the siloxane pends on a lateral side of the polyimide as a branched chain;

(II) the connective group R in the siloxane connects with the polyimide, such that the whole siloxane pends on a lateral side of the polyimide as a branched chain.

The polyimide chain is

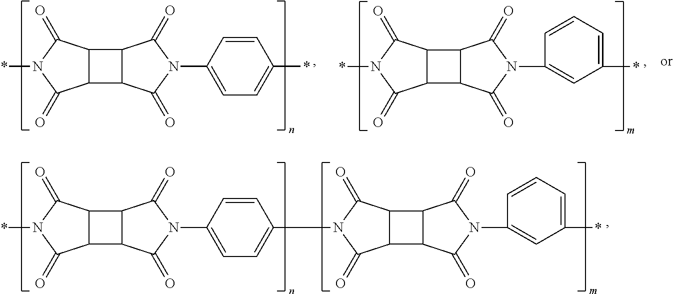

and wherein n and m are integers greater than 0.

The siloxane is a branched siloxane, the formula of the branched siloxane is R₁SiₙOₙ₋₁R′₂ₙ₊₁, wherein n=4 or 13, R is —(CO)OH, —(CO)NH₂, —OH, or

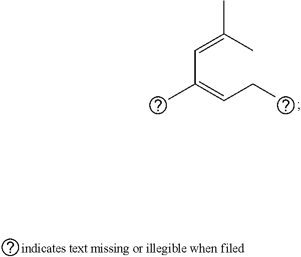

R′ is a C3-10 linear alkyl or a branched alkyl, a C3-10 linear alkyl or a branched alkyl in which a CH₂ is substituted by —CH═CH—, —C≡C—, phenyl, cycloalkyl, or a phenyl;

wherein the diameter of the branched siloxane is 1-3 nm.

The siloxane is a caged oligomeric silsesquioxane, the formula of the caged oligomeric silsesquioxane is R₁SiₙO_{1.5n}R′ₙ₋₁, wherein n=6, 8, 10, or 12, R is —(CO)OH, —(CO)NH₂, —OH, or

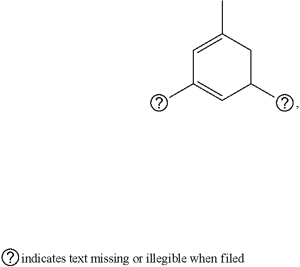

R′ is a C3-10 linear alkyl or a branched alkyl, a C3-10 linear alkyl or a branched alkyl in which a CH₂ is substituted by —CH═CH—, —C≡C—, phenyl, cycloalkyl, or a phenyl;

wherein the diameter of the caged oligomeric silsesquioxane is 1-3 nm.

The mass percentage of the siloxane in the polymer is 1˜50 wt %.

The disclosure further provides a method for preparing an orientation film, comprising the following steps:

Step 1, measuring siloxane, dianhydride monomer and diamine monomer in a mole ratio of 1˜50:100:50˜99;

Step 2, providing an appropriate amount of a solvent, dissolving the measured dianhydride monomer, siloxane and diamine monomer in step 1 in the solvent, and obtaining a precursor of orientation film;

Step 3, providing a substrate, coating the precursor of orientation film prepared in step 2 on the surface of the substrate;

Step 4, pre-solidifying the precursor of orientation film disposed on the substrate, the temperature of pre-solidifying is 100˜130° C., and the time of pre-solidifying is 1˜10 min;

Step 5, main-solidifying the precursor of orientation film disposed on the substrate, the temperature of main-solidifying is 210˜240° C., the time of main-solidifying is 20˜40 min, and obtaining an orientation film.

The siloxane is a branched siloxane or a caged oligomeric silsesquioxane.

The solvent is N-methylpyrrolidone, N-ethylpyrrolidine, butylrolcatone, or the combination thereof.

The precursor of orientation film prepared in step 2 comprises siloxane, dianhydride monomer, diamine monomer and a solvent, wherein the mole ratio of the siloxane n1, the dianhydride monomer n2 and the diamine monomer n3 is 1˜50:100:50˜99, and n2=n1+n3; and the mass percentage of the siloxane in the precursor of orientation film is 0.01˜0.5 wt %.

The disclosure further provides a method for preparing an orientation film, comprising the following steps:

Step 1, measuring siloxane, dianhydride monomer and diamine monomer in a mole ratio of 1˜50:100:50˜99;

Step 2, providing an appropriate amount of a solvent, dissolving the measured dianhydride monomer, siloxane and diamine monomer in step 1 in the solvent, and obtaining a precursor of orientation film;

Step 3, providing a substrate, coating the precursor of orientation film prepared in step 2 on the surface of the substrate;

Step 4, pre-solidifying the precursor of orientation film disposed on the substrate, the temperature of pre-solidifying is 100˜130° C., and the time of pre-solidifying is 1˜10 min;

Step 5, main-solidifying the precursor of orientation film disposed on the substrate, the temperature of main-solidifying is 210˜240° C., the time of main-solidifying is 20˜40 min, and obtaining an orientation film.

Wherein in step 1, the siloxane is a branched siloxane or a caged oligomeric silsesquioxane.

Wherein in step 2, the solvent is N-methylpyrrolidone, N-ethylpyrrolidine, butylrolcatone, or the combination thereof.

Wherein the precursor of orientation film prepared in step 2 comprises siloxane, dianhydride monomer, diamine monomer and a solvent, wherein the mole ratio of the siloxane n1, the dianhydride monomer n2 and the diamine monomer n3 is 1˜50:100:50˜99, and n2=n1+n3; and the mass percentage of the siloxane in the precursor of orientation film is 0.01˜0.5 wt %.

The disclosure has the following advantages: the disclosure provides a polymer used for orientation film material and a method for preparing an orientation film. The polymer is formed by siloxane connecting with polyimide. The pre-tilt angle of liquid crystal molecules can be controlled within a wide range by controlling the content of siloxane in polymer, and the polymer has great heat resistance and mechanical properties. The method for preparing an orientation film of the disclosure comprises forming a precursor of orientation film by dissolving siloxane and precursor of polyimide (diamine monomer, dianhydride monomer) in a solvent, coating the precursor of orientation film on a substrate, and obtaining the orientation film after pre-solidifying and main-solidifying, the steps are simple and the prepared orientation film has a wide range of pre-tilt angle, such that the pre-tilt angle of liquid crystal molecules in the liquid crystal panels of the orientation film can be controlled within a wide range.

In order to more clearly illustrate the features and technical solutions of the disclosure, the accompanying descriptions and drawings are described as blow. It is apparently that the drawings below are merely some embodiments of the disclosure, which do not limit the scope of the disclosure.

### BRIEF DESCRIPTION OF THE DRAWINGS

In order to more clearly illustrate the embodiments of the disclosure, the accompanying drawings for illustrating the technical solutions and the technical solutions of the disclosure are briefly described as below.

FIG. 1 is a schematic view of a molecular structure of a polymer used for orientation film material according to the disclosure; and

FIG. 2 is a flow chart of the method for preparing an orientation film according to the disclosure.

### DETAILED DESCRIPTION

The following description with reference to the accompanying drawings is provided to clearly and completely explain the exemplary embodiments of the disclosure. It is apparent that the following embodiments are merely some embodiments of the disclosure rather than all embodiments of the disclosure. According to the embodiments in the disclosure, all the other embodiments attainable by those skilled in the art without creative endeavor belong to the protection scope of the disclosure.

First of all, the disclosure provides a polymer used for orientation film material, comprising a polyimide chain and a siloxane, connected with the polyimide chain as a side chain, wherein the siloxane has a connective group R and a functional group R′, the connective group R is configured for connecting with the polyimide, and the functional group R′ is configured for controlling a pre-tilt angle of liquid crystal molecules so as to achieve orientating.

Specifically, the siloxane and the polyimide are connected by one of the following methods:

(I) the connective group R in the siloxane connects with the polyimide, such that the other portion besides the connective group R in the siloxane pends on a lateral side of the polyimide as a branched chain;

(II) the connective group R in the siloxane connects with the polyimide, such that the whole siloxane pends on a lateral side of the polyimide as a branched chain.

Specifically, the polyimide chain is

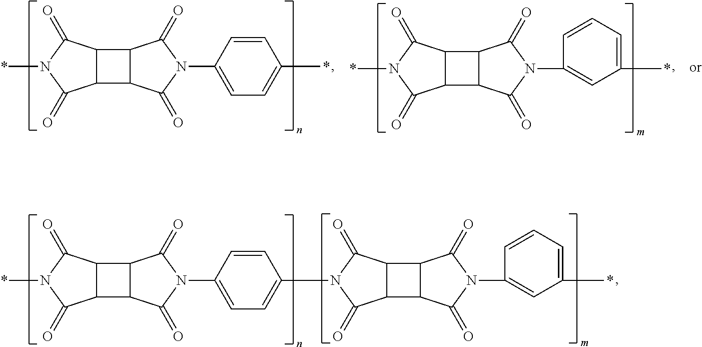

and wherein n and m are integers greater than 0.

Specifically, the siloxane is a branched siloxane or a caged oligomeric silsesquioxane.

The formula of the branched siloxane is R₁SiₙOₙ₋₁R′₂ₙ₊₁, wherein n=4 or 13, R is —(CO)OH, —(CO)NH₂, —OH, or

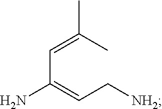

R′ is a C3-10 linear alkyl or a branched alkyl, a C3-10 linear alkyl or a branched alkyl in which a CH₂ is substituted by —CH═CH—, —C≡C—, phenyl, cycloalkyl, or a phenyl.

Specifically, the connective group R is configured for connecting with the polyimide, and the functional group R′ is configured for controlling a pre-tilt angle of liquid crystal molecules so as to achieve orientating.

When n in the formula R₁SiₙOₙ₋₁R′₂ₙ₊₁ of the branched siloxane is 4 and 13 respectively, the structural formulas of the branched siloxane are respectively shown as (A) and (B):

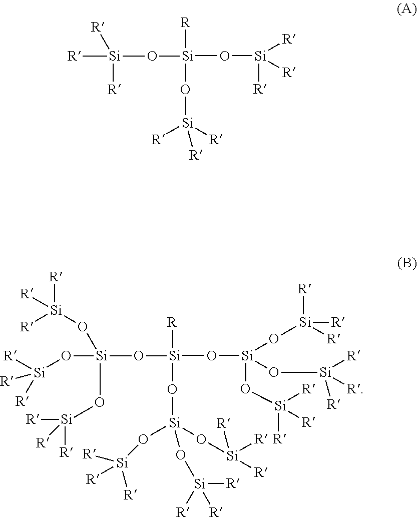

Specifically, the diameter of the branched siloxane is 1-3 nm.

The formula of the caged oligomeric silsesquioxane is R₁SiₙO_{1.5n}R′ₙ₋₁, wherein n=6, 8, 10, or 12, R is —(CO)OH, —(CO)NH₂, —OH, or

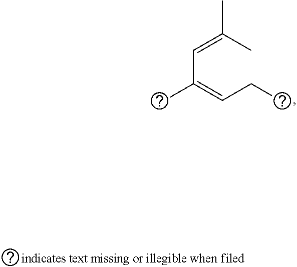

R′ is a C3-10 linear alkyl or a branched alkyl, a C3-10 linear alkyl or a branched alkyl in which a CH₂ is substituted by —CH═CH—, phenyl, cycloalkyl, or a phenyl.

Specifically, the connective group R is configured for connecting with the polyimide, and the functional group R′ is configured for controlling a pre-tilt angle of liquid crystal molecules so as to achieve orientating.

Specifically, the diameter of the caged oligomeric silsesquioxane is 1-3 nm.

When n in the formula R₁SiₙO_{1.5n}R′ₙ₋₁ of the caged oligomeric silsesquioxane is 6, 8, 10 and 12 respectively, the structural formulas of the branched siloxane are respectively shown as (E), (F), (G) and (H):

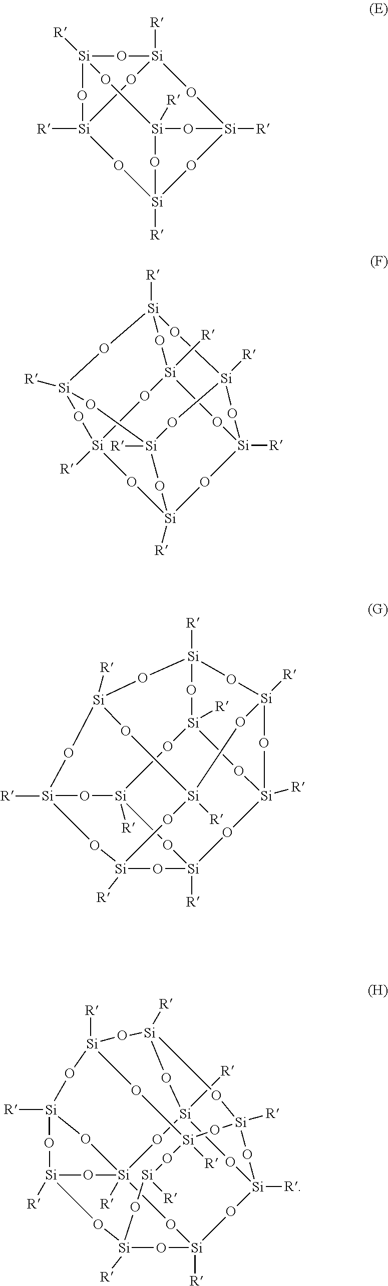

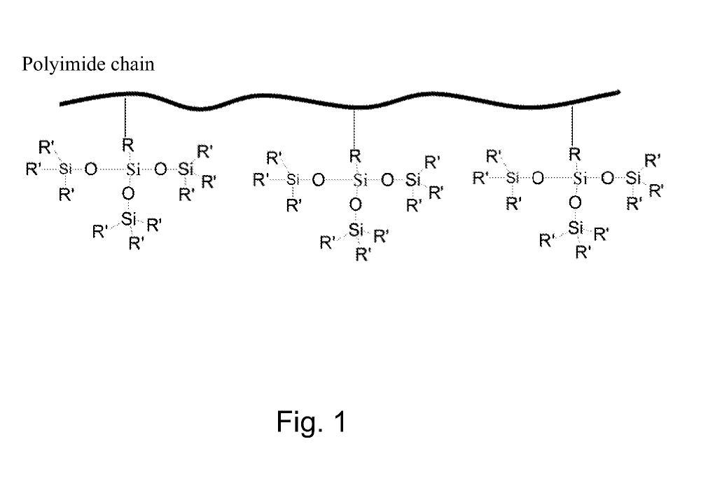

FIG. 1 is a schematic view of a molecular structure of a polymer used for orientation film material according to the disclosure, as shown in FIG. 1, the polymer comprises a polyimide chain and a branched siloxane connected with the polyimide as a side chain, the structure of the branched siloxane is shown as formula (A), the branched siloxane connects with the polyimide by R, such that the whole siloxane pends on a lateral side of the polyimide as a branched chain.

Preferably, the mass percentage of the siloxane in the polymer is 1˜50 wt %.

Specifically, the mechanism of generating pre-tilt angle on the surface of the orientation film is:

(1) explanation of orientation in the view of energy: the mechanism of siloxane in the orientation film is similar to friction orientation, which generates a directional angle at the surface of the orientation film, such that the major axis of the liquid crystal molecules and the direction of R′ in the siloxane are identical so as to achieve a stable state, which has the lowest energy, and the liquid crystal molecules arrange along a certain direction, and the lowering level of energy relates to the content of the branched siloxane in the orientation film, when the content of siloxane is greater, the surface energy of the orientation film decreases more, such that the pre-tilt angle of the liquid crystal molecules can be controlled.

(2) explanation of orientation in the view of surface molecular chains: the liquid crystal molecules of the siloxane form the pre-tilt angle by steric effect of R′ in the orientation film, and the result of orientating would be affected by the content of siloxane, i.e., the quantity of R′.

According to the polymer used for orientation film material of the disclosure, the polymer comprises a polyimide chain and a siloxane connected with the polyimide as a side chain, the siloxane has a connective group R configured for connecting with the polyimide and a functional group R′ configured for controlling a pre-tilt angle of liquid crystal molecules, specifically, the pre-tilt angle of liquid crystal molecules can be controlled between 0° and 90° by controlling the content of siloxane in polymer, such that the orientation film has a greater range of pre-tilt angle, and the pre-tilt angle of liquid crystal molecules can be controlled within a wide range; meanwhile, the polymer has great heat resistance and mechanical properties.

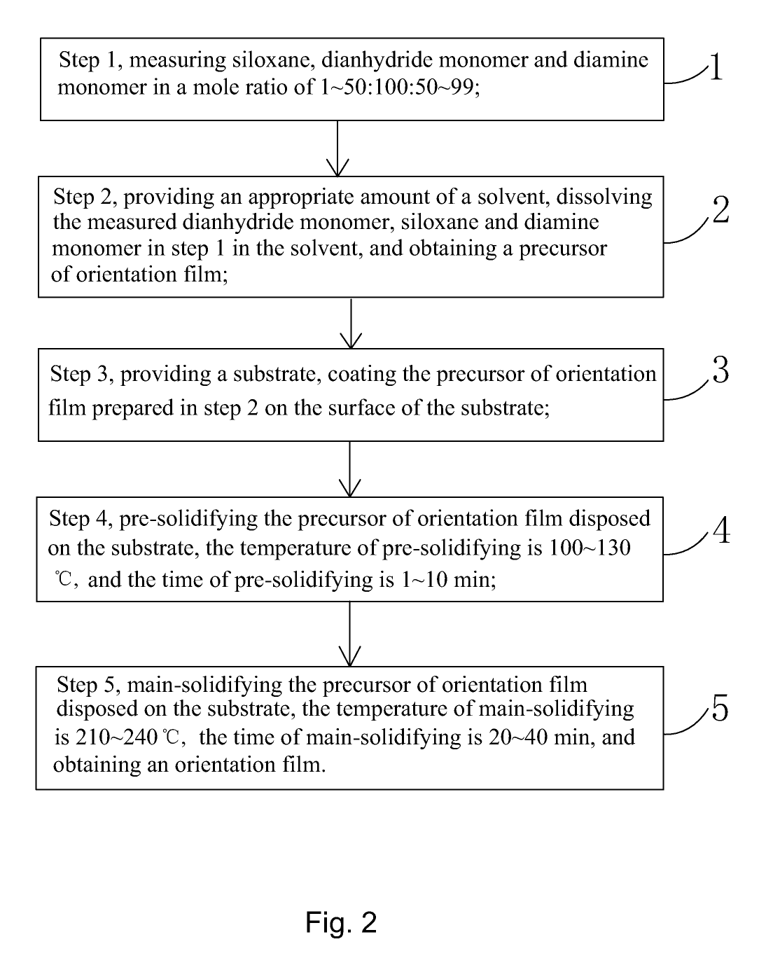

Referring to FIG. 2, the disclosure further provides a method for preparing an orientation film, comprising the following steps:

Step 1, measuring siloxane, dianhydride monomer and diamine monomer in a mole ratio of 1˜50:100:50˜99.

Specifically, the siloxane is a branched siloxane or a caged oligomeric silsesquioxane.

The structures of the branched siloxane and the caged oligomeric silsesquioxane are described above, such that they are not described again.

Specifically, the structural formula of the dianhydride monomer can be:

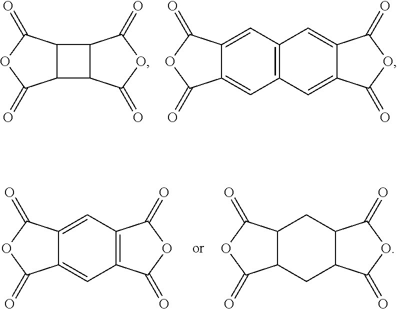

Specifically, the structural formula of the diamine monomer can be:

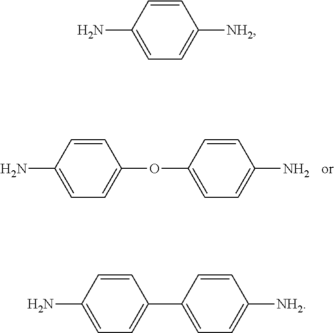 [SMILES: Nc1ccc(N)cc1 ; Nc1ccc(Oc2ccc(N)cc2)cc1 ; "or" ; Nc1ccc(-c2ccc(N)cc2)cc1]

Step 2, providing an appropriate amount of a solvent, dissolving the measured dianhydride monomer, siloxane and diamine monomer in step 1 in the solvent, and obtaining a precursor of orientation film.

Specifically, the solvent is N-methylpyrrolidone, N-ethylpyrrolidine, butylrolcatone, or the combination thereof.

The precursor of orientation film prepared in step 2 comprises siloxane, dianhydride monomer, diamine monomer and a solvent, wherein the mole ratio of the siloxane n1, the dianhydride monomer n2 and the diamine monomer n3 is 1˜50:100:50˜99, and n2=n1+n3.

Preferably, the mass percentage of the siloxane in the precursor of orientation film is 0.01˜0.5 wt %.

Step 3, providing a substrate, coating the precursor of orientation film prepared in step 2 on the surface of the substrate.

Step 4, pre-solidifying the precursor of orientation film disposed on the substrate, the temperature of pre-solidifying is 100˜130° C., and the time of pre-solidifying is 1˜10 min.

Step 5, main-solidifying the precursor of orientation film disposed on the substrate, the temperature of main-solidifying is 210˜240° C., the time of main-solidifying is 20˜40 min, and obtaining an orientation film.

The disclosure provides a method for preparing an orientation film comprises forming a precursor of orientation film by dissolving siloxane and precursor of polyimide (diamine monomer, dianhydride monomer) in a solvent, coating the precursor of orientation film on a substrate, and obtaining the orientation film after pre-solidifying and main-solidifying, the steps are simple and the prepared orientation film has a wide range of pre-tilt angle, such that the pre-tilt angle of liquid crystal molecules in the liquid crystal panels of the orientation film can be controlled within a wide range.

Preferred embodiment 1 of the method for preparing an orientation film of the disclosure:

Step 1, measuring siloxane (b), dianhydride monomer (a) and diamine monomer (c) in a mole ratio of m:n:(n−m)=1˜50:100:50˜99.

Step 2, incorporating siloxane (b), dianhydride monomer (a) and diamine monomer (c) in a mixture of solvent constituted of N-methylpyrrolidone, N-ethylpyrrolidine, butylrolcatone and the combination. After dissolving, a precursor of orientation film is obtained.

Step 3, providing a substrate, coating the precursor of orientation film prepared in step 2 on the surface of the substrate.

Step 4, pre-solidifying the precursor of orientation film disposed on the substrate, the temperature of pre-solidifying is 100˜130° C., and the time of pre-solidifying is 1˜10 min.

Step 5, main-solidifying the precursor of orientation film disposed on the substrate, the temperature of main-solidifying is 210˜240° C., the time of main-solidifying is 20˜40 min, and obtaining an orientation film.

Specifically, in steps 4 and 5, chemical reaction of the precursor of orientation film disposed on the substrate during the processes of pre-solidifying and main-solidifying are shown as below:

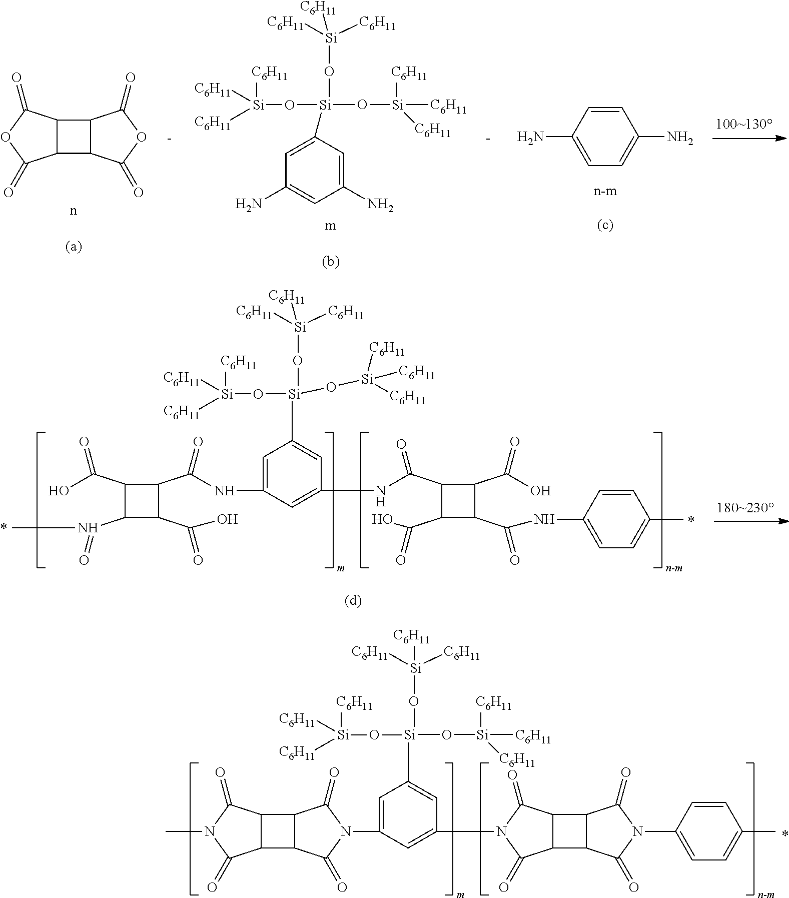

An orientation film is prepared in step 5, the material of the orientation film is a polymer, the structural formula of the polymer is

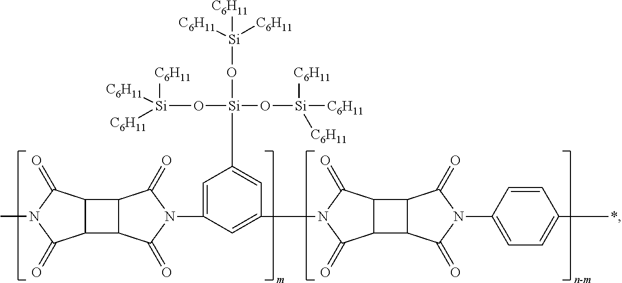

wherein m=20˜5--, n=20˜500, and n>m.

According to the structural formula of the polymer, the branched siloxane (b) connects with the polyimide by its connective group

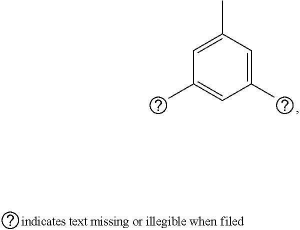

such that the other portion besides the connective group

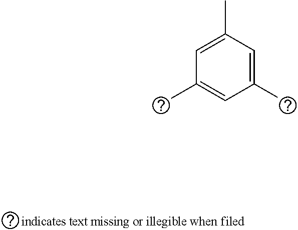

in the siloxane pends on a lateral side of the polyimide as a branched chain.

According to the above description, the disclosure provides a polymer used for orientation film material and a method for preparing an orientation film. The polymer is formed by siloxane connecting with polyimide. The pre-tilt angle of liquid crystal molecules can be controlled within a wide range by controlling the content of siloxane in polymer, and the polymer has great heat resistance and mechanical properties. The method for preparing an orientation film of the disclosure comprises forming a precursor of orientation film by dissolving siloxane and precursor of polyimide (diamine monomer, dianhydride monomer) in a solvent, coating the precursor of orientation film on a substrate, and obtaining the orientation film after pre-solidifying and main-solidifying, the steps are simple and the prepared orientation film has a wide range of pre-tilt angle, such that the pre-tilt angle of liquid crystal molecules in the liquid crystal panels of the orientation film can be controlled within a wide range.

Note that the specifications relating to the above embodiments should be construed as exemplary rather than as limitative of the present disclosure. The equivalent variations and modifications on the structures or the process by reference to the specification and the drawings of the disclosure, or application to the other relevant technology fields directly or indirectly should be construed similarly as falling within the protection scope of the disclosure.

What is claimed is:

1. A polymer used for orientation film material, comprising: a polyimide chain; and a siloxane, connected with the polyimide chain as a side chain, wherein the siloxane has a connective group R and a functional group R′, the connective group R is configured for connecting with the polyimide, and the functional group R′ is configured for controlling a pre-tilt angle of liquid crystal molecules so as to achieve orientating.

2. The polymer used for orientation film material according to claim 1, wherein the siloxane and the polyimide are connected by one of the following methods:
(I) the connective group R in the siloxane connects with the polyimide, such that the other portion besides the connective group R in the siloxane pends on a lateral side of the polyimide as a branched chain;
(II) the connective group R in the siloxane connects with the polyimide, such that the whole siloxane pends on a lateral side of the polyimide as a branched chain.

3. The polymer used for orientation film material according to claim 1, wherein the polyimide chain is 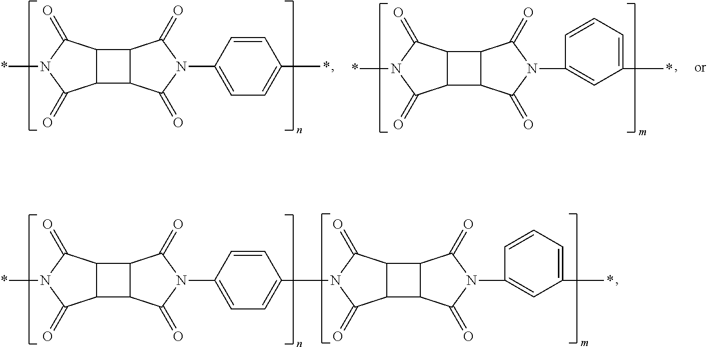
and wherein n and m are integers greater than 0.

4. The polymer used for orientation film material according to claim 1, wherein the siloxane is a branched siloxane, the formula of the branched siloxane is R₁SiₙOₙ₋₁R′₂ₙ₊₁, wherein n=4 or 13, R is —(CO)OH, —(CO)NH₂, —OH, or 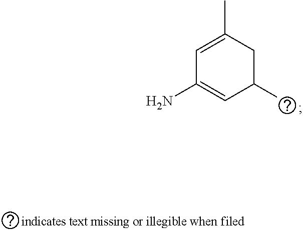
R′ is a C3-10 linear alkyl or a branched alkyl, a C3-10 linear alkyl or a branched alkyl in which a CH₂ is substituted by —CH═CH—, —C≡C—, phenyl, cycloalkyl, or a phenyl;
wherein the diameter of the branched siloxane is 1-3 nm.

5. The polymer used for orientation film material according to claim 1, wherein the siloxane is a caged oligomeric silsesquioxane, the formula of the caged oligomeric silsesquioxane is R₁SiₙO_{1.5n}R′ₙ₋₁, wherein n=6, 8, 10, or 12, R is —(CO)OH, —(CO)NH₂, —OH, or 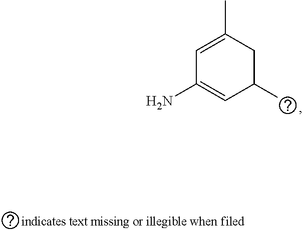
R′ is a C3-10 linear alkyl or a branched alkyl, a C3-10 linear alkyl or a branched alkyl in which a CH₂ is substituted by —CH═CH—, —C≡C—, phenyl, cycloalkyl, or a phenyl;
wherein the diameter of the caged oligomeric silsesquioxane is 1-3 nm.

6. The polymer used for orientation film material according to claim 1, wherein the mass percentage of the siloxane in the polymer is 1˜50 wt %.

7. A method for preparing an orientation film, comprising:
step 1, measuring siloxane, dianhydride monomer and diamine monomer in a mole ratio of 1˜50:100:50˜99;
step 2, providing an appropriate amount of a solvent, dissolving the measured dianhydride monomer, siloxane and diamine monomer in step 1 in the solvent, and obtaining a precursor of orientation film;
step 3, providing a substrate, coating the precursor of orientation film prepared in step 2 on the surface of the substrate;
step 4, pre-solidifying the precursor of orientation film disposed on the substrate, the temperature of pre-solidifying is 100˜130° C., and the time of pre-solidifying is 1˜10 min;
step 5, main-solidifying the precursor of orientation film disposed on the substrate, the temperature of main-solidifying is 210˜240° C., the time of main-solidifying is 20˜40 min, and obtaining an orientation film.

8. The method for preparing an orientation film according to claim 7, wherein in step 1, the siloxane is a branched siloxane or a caged oligomeric silsesquioxane.

9. The method for preparing an orientation film according to claim 7, wherein in step 2, the solvent is N-methylpyrrolidone, N-ethylpyrrolidine, butylrolcatone, or the combination thereof.

10. The method for preparing an orientation film according to claim 7, wherein the precursor of orientation film prepared in step 2 comprises siloxane, dianhydride monomer, diamine monomer and a solvent, wherein the mole ratio of the siloxane n1, the dianhydride monomer n2 and the diamine monomer n3 is 1˜50:100:50˜99, and n2=n1+n3;
the mass percentage of the siloxane in the precursor of orientation film is 0.01˜0.5 wt %.

11. A method for preparing an orientation film, comprising:
step 1, measuring siloxane, dianhydride monomer and diamine monomer in a mole ratio of 1˜50:100:50˜99;
step 2, providing an appropriate amount of a solvent, dissolving the measured dianhydride monomer, siloxane and diamine monomer in step 1 in the solvent, and obtaining a precursor of orientation film;
step 3, providing a substrate, coating the precursor of orientation film prepared in step 2 on the surface of the substrate;
step 4, pre-solidifying the precursor of orientation film disposed on the substrate, the temperature of pre-solidifying is 100˜130° C., and the time of pre-solidifying is 1˜10 min;
step 5, main-solidifying the precursor of orientation film disposed on the substrate, the temperature of main-solidifying is 210˜240° C., the time of main-solidifying is 20˜40 min, and obtaining an orientation film;
wherein in step 1, the siloxane is a branched siloxane or a caged oligomeric silsesquioxane;
wherein in step 2, the solvent is N-methylpyrrolidone, N-ethylpyrrolidine, butylrolcatone, or the combination thereof;
wherein the precursor of orientation film prepared in step 2 comprises siloxane, dianhydride monomer, diamine monomer and a solvent, wherein the mole ratio of the siloxane n1, the dianhydride monomer n2 and the diamine monomer n3 is 1˜50:100:50˜99, and n2=n1+n3; and
the mass percentage of the siloxane in the precursor of orientation film is 0.01˜0.5 wt %.
